(19) United States
(12) Patent Application Publication
(10) Pub. No.: US 2026/0119215 A1
(43) Pub. Date: Apr. 30, 2026

(54) ELECTRONIC DEVICE AND CONTROL METHOD THEREOF

(71) Applicant: Samsung Electronics Co., Ltd., Suwon-si (KR)

(72) Inventors: Jinhwan KIM, Suwon-si (KR); Seongil HAHM, Suwon-si (KR)

(21) Appl. No.: 19/004,927

(22) Filed: Dec. 30, 2024

Related U.S. Application Data
(63) Continuation of application No. PCT/KR2023/012648, filed on Aug. 25, 2023.

(30) Foreign Application Priority Data
Oct. 14, 2022 (KR) 10-2022-0132363

(51) Int. Cl. G06F 9/451; H04L 41/0631; H04L 41/22

(52) U.S. Cl. CPC G06F 9/453; H04L 41/0631; H04L 41/22

(57) ABSTRACT

An electronic device is provided. The electronic device includes memory for storing a plurality of response information and one or more computer programs, communication circuitry for communication with an external device connected to a server, and one or more processors communicatively coupled to the communication circuitry and the memory, wherein the one or more computer programs include computer-executable instructions that, when executed by the one or more processors individually or collectively, cause the electronic device to, based on the external device and the server being connected, receive a first packet including first connection state information from the external device through the communication circuitry, based on there being an event in which the external device is not connected to the server, receive a second packet including a cause of the event occurrence and second connection state information from the external device through the communication circuitry, based on identifying that the external device is disconnected from the server based on the second connection state information included in the second packet, identify response information, which corresponds to the cause of the event occurrence included in the second packet, among a plurality of response information stored in the memory, generate a user interface (UI) guiding to connect the external device to the server based on the response information, and providing the UI.

### CROSS-REFERENCE TO RELATED APPLICATION(S)

This application is a continuation application, claiming priority under § 365(c), of an International application No. PCT/KR2023/012648, filed on Aug. 25, 2023, which is based on and claims the benefit of a Korean patent application number 10-2022-0132363, filed on Oct. 14, 2022, in the Korean Intellectual Property Office, the disclosure of which is incorporated by reference herein in its entirety.

### BACKGROUND

### 1. Field

The disclosure relates to an electronic device and a controlling method thereof. More particularly, the disclosure relates to an electronic device providing a relevant user interface (UI) to a user if there is an event that an external device and a server is disconnected and a controlling method thereof.

### 2. Description of Related Art

A smart home appliance makes it possible for a user to connect to the Internet and use various services such as monitoring and controlling through the web or a mobile phone. Connection of the smart home appliance with a router, a server, or the like may not be smooth due to various reasons (e.g. a distance problem, physical disconnection, a performance of a communication antenna, a network state, replacement of the router, a change of a password, other connection problems, etc.)

If there is no separate input part or there is a restrictive input part according to a type of smart home appliance, it may be difficult for the user to directly manipulate the smart home appliance. For example, if the smart home appliance includes only a restrictive light emitting diode (LED), it may be difficult for the user to directly manipulate the smart home appliance.

If the smart home appliance is disconnected from the server (if it is in an offline state), it may be difficult for the user to know a reason for disconnection between the smart home appliance and the server. Even though the smart home appliance stores information about the reason for disconnection from the server, if the smart home appliance itself does not include an output part or includes only a restrictive LED, it may be difficult for the smart home appliance to completely provide information about the reason of disconnection to the user.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device providing a user interface (UI) receiving a reason for an event of disconnection between an external device and a server from the external device and guiding to a response to the reason for the event occurrence and a controlling method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory storing a plurality of response information and one or more computer programs, communication circuitry communicating with an external device connected to a server, and one or more processors communicatively coupled to the communication circuitry and the memory, wherein the one or more computer programs include computer-executable instructions that, when executed by the one or more processors individually or collectively, cause the electronic device to, based on the external device being connected to the server, receive a first packet including first connection state information from the external device through the communication circuitry, based on there being an event that the external device is not connected to the server, receive a second packet including second connection state information and a reason for event occurrence from the external device through the communication circuitry, based on identifying that the external device is disconnected from the server based on the second connection state information included in the second packet, identify response information corresponding to the reason for the event occurrence included in the second packet among the plurality of response information stored in the memory, generate a user interface (UI) guiding to connect the external device to the server based on the response information, and provide the UI.

Meanwhile, the communication circuitry includes at least one module among a Wireless Fidelity (Wi-Fi) module and a Bluetooth (BT) module, wherein the at least one processor may receive the first packet and the second packet in a broadcasting method through the at least one module.

Meanwhile, the reason for the event occurrence includes at least one of a reason related to a router, a reason related to Internet connection, a reason related to power, or a reason related to the server.

Meanwhile, the at least one processor may generate the UI including at least one of identification information of the external device, information indicating the event, the reason for the event occurrence, or the response information.

Meanwhile, the electronic device furthers include memory storing a response table mapping a plurality of reasons for event occurrence and response information for resolving each of the plurality of reasons for the event occurrence, wherein the at least one processor may identify the response information corresponding to the reasons for the event occurrence based on the response table.

Meanwhile, the at least one processor further includes memory storing a registration device table including identification information of at least one pre-registered external device, receive the second packet including the second connection state information, the reason for the event occurrence, and the identification information of the external device through the communication circuitry, and based on the identification information of the external device included in the second packet being included in the registration device table, identify the response information.

The electronic device further includes memory storing a response table mapping a plurality of reasons for event occurrence and response information for resolving each of the plurality of reasons for the event occurrence, wherein the at least one processor, based on the identification information of the external device being included in the registration device table, and the response information corresponding to the reason for the event occurrence being included in the response table, may generate a first UI guiding to reconnect the external device to the server and provide the first UI, and based on the identification information of the external device being included in the registration device table, and the response information corresponding to the reason for the event occurrence being not included in the response table, may generate a second UI guiding to reconnect the external device to the server and provide the second UI.

Meanwhile, the at least one processor, after a preset threshold time is elapsed from a time point when the first UI is provided, may receive a third packet including third connection state information from the external device through the communication circuitry, and based on identifying that the external device is disconnected from the server according to the third connection state information included in the third packet, may generate the second UI guiding to reconnect the external device to the server and provide the second UI.

Meanwhile, the at least one processor, based on the identification information included in the second packet being not included in the registration device table, may generate a third UI guiding to newly register the external device at the server.

Meanwhile, the electronic device further includes a display, wherein the at least one processor may control the display to display the UI.

In accordance with another aspect of the disclosure, a method performed by an electronic device for communicating with an external device which stores a plurality of response information and is connected to a server is provided. The method includes based on the external device being connected to the server, receiving, by the electronic device, a first packet including first connection state information from the external device, based on there being an event that the external device is not connected to the server, receiving, by the electronic device, a second packet including second connection state information and a reason for event occurrence from the external device, based on it being identified that the external device is disconnected from the server based on the second connection state information included in the second packet, identifying, by the electronic device, response information corresponding to the reason for the event occurrence included in the second packet among the plurality of stored response information, generating, by the electronic device, a user interface (UI) guiding to connect the external device to the server based on the response information, and providing the UI.

Meanwhile, communication circuitry of the electronic device includes at least one module among a Wireless Fidelity (Wi-Fi) module and a Bluetooth (BT) module, wherein the receiving the first packet and the second packet may include receiving the first packet and the second packet in a broadcasting method through the at least one module.

Meanwhile, the reason for the event occurrence includes at least one of a reason related to a router, a reason related to Internet connection, a reason related to power, or a reason related to the server.

Meanwhile, the generating the UI includes generating the UI including at least one of identification information of the external device, information indicating the event, the reason for the event occurrence, or the response information.

Meanwhile, the electronic device stores a response table mapping a plurality of reasons for event occurrence and response information for resolving each of the plurality of reasons for the event occurrence, wherein the identifying the response information may include identifying the response information corresponding to the reasons for the event occurrence based on the response table.

Meanwhile, the electronic device stores a registration device table including identification information of at least one pre-registered external device, wherein the receiving the second packet may include receiving the second connection state information, the reason for the event occurrence, and the identification information of the external device, and the identifying the response information may include, based on the identification information of the external device included in the second packet being included in the registration device table, identifying the response information.

Meanwhile, the electronic device stores a response table mapping a plurality of reasons for event occurrence and response information for resolving each of the plurality of reasons for the event occurrence, wherein the control method may include, based on the identification information of the external device being included in the registration device table, and the response information corresponding to the reason for the event occurrence being included in the response table, generating a first UI guiding to reconnect the external device to the server and provide the first UI, and based on the identification information of the external device being included in the registration device table, and the response information corresponding to the reason for the event occurrence being not included in the response table, generating a second UI guiding to reconnect the external device to the server and providing the second UI.

Meanwhile, the control method includes after a preset threshold time is elapsed from a time point when the first UI is provided, receiving a third packet including third connection state information from the external device, and based on identifying that the external device is disconnected from the server according to the third connection state information included in the third packet, generating the second UI guiding to reconnect the external device to the server and providing the second UI.

Meanwhile, the control method further includes based on the identification information included in the second packet being not included in the registration device table, generating a third UI guiding to newly register the external device at the server.

Meanwhile, the control method further includes displaying the UI on the display of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include based on an external device being connected to a server, receiving, by the electronic device, a first packet including first connection state information from the external device, based on there being an event that the external device is not connected to the server, receiving, by the electronic device, a second packet including second connection state information and a reason for event occurrence from the external device, based on it being identified that the external device is disconnected from the server based on the second connection state information included in the second packet, identifying, by the electronic device, response information corresponding to the reason for the event occurrence included in the second packet among a plurality of stored response information, generating, by the electronic device, a user interface (UI) guiding to connect the external device to the server based on the response information, and providing, by the electronic device, the UI.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a system including an electronic device, an external device, and a server according to an embodiment of the disclosure;

FIG. 2 is a view illustrating a system including an electronic device, an external device, a server, and a router according to an embodiment of the disclosure;

FIG. 3 is a block diagram illustrating a configuration of an electronic device according to an embodiment of the disclosure;

FIG. 4 is a block diagram illustrating a detailed configuration of the electronic device of FIG. 3 according to an embodiment of the disclosure;

FIG. 5 is a flow chart illustrating an operation of generating response information corresponding to a reason for event occurrence according to an embodiment of the disclosure;

FIG. 6 is a flow chart illustrating an operation of generating response information corresponding to a reason for event occurrence according to an embodiment of the disclosure;

FIG. 7 is a flow chart illustrating an operation of generating response information based on a packet transmitted from an external device according to an embodiment of the disclosure;

FIG. 8 is a table representing response information corresponding to a reason of event occurrence according to an embodiment of the disclosure;

FIG. 9 is a view illustrating a UI including response information according to an embodiment of the disclosure;

FIG. 10 is a view illustrating a packet including a reason for event occurrence according to an embodiment of the disclosure;

FIG. 11 is a flow chart illustrating an operation of determining broadcasting of a packet according to an embodiment of the disclosure;

FIG. 12 is a flow chart illustrating an operation of determining whether an external device is pre-registered according to an embodiment of the disclosure;

FIG. 13 is a flow chart illustrating an operation of guiding to newly register an external device according to an embodiment of the disclosure;

FIG. 14 is a flow chart illustrating an operation of generating various UIs according to an embodiment of the disclosure;

FIG. 15 is a view illustrating a UI guiding to reconnect an external device to a server according to an embodiment of the disclosure;

FIG. 16 is a view illustrating a UI guiding to reregister an external device at a server according to an embodiment of the disclosure;

FIG. 17 is a view illustrating a UI guiding to newly register an external device at a server according to an embodiment of the disclosure;

FIG. 18 is a flow chart illustrating an operation of determining whether an external device is connected to a server after providing the UI according to an embodiment of the disclosure;

FIG. 19 is a flow chart illustrating an operation of generating a UI according to a user input requesting for resolution after providing the UI according to an embodiment of the disclosure; and

FIG. 20 is a view illustrating a method of controlling an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the specification, the expression such as “have”, “may have”, “include”, or “may include” denotes the existence of such a characteristic (e.g. a numerical value, a function, an operation, or a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

Meanwhile, the description that one element (e.g. a first element) is “(operatively or communicatively) coupled with/to” or “connected to” another element (e.g. a second element) should be interpreted to include both the case where the one element is directly coupled to the other element, and the case where the one element is coupled to the other element through the other element (e.g. a third element).

In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, “module” or “part” may perform at least one function or operation and may be implemented as hardware or software, or as a combination of hardware and software. Also, a plurality of “modules” or “parts” may be integrated into at least one module and implemented as at least one processor (not shown), excluding a “module” or a “part” that needs to be implemented as specific hardware.

In the specification, the term “user” may refer to a person who uses an electronic device or a device that uses an electronic device (e.g. an Artificial Intelligence (AI) electronic device).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

Hereinafter, an embodiment of the disclosure is more specifically described with reference to the appended drawings.

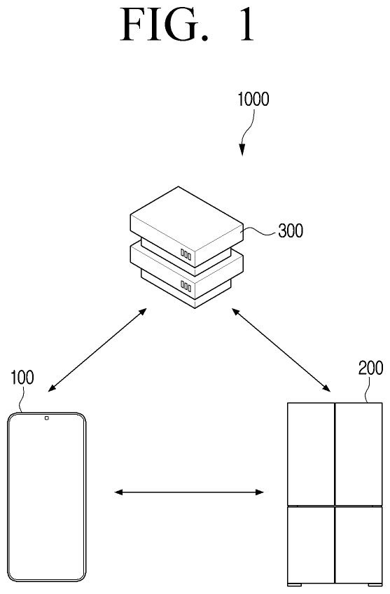

FIG. 1 is a view illustrating a system including an electronic device 100, an external device, and a server according to an embodiment of the disclosure.

Referring to FIG. 1, a system 1000 may include at least one of the electronic device 100, an external device 200 or a server 300. The system 1000 may represent an Internet of Things (IoT) network configured in a certain space (e.g. home). The electron device 100 may perform communication with the server 300. The external device 200 may perform communication with the server 300. The server 300 may control at least one device disposed in the certain space.

The electronic device 100 and the external device 200 may be home appliances included in the IoT network. The electronic device 100 may be a device having an output part (a display or a speaker).

The server 300 may receive and store various information from the electronic device 100 or the external device 200. On the contrary, the server 300 may transmit various information to the electronic device 100 or the external device 200. The various information may mean information collected from a device itself, information related to a control command, information related to a software update, etc.

The electronic device 100 may perform communication with the external device 200. The electronic device 100 may perform communication with the external device 200 by using Wi-Fi communication or Bluetooth communication. The electronic device 100 and the external device 200 may mutually send and receive various information.

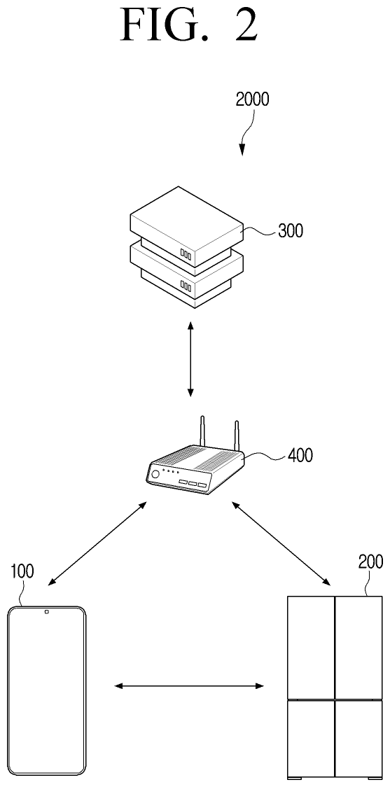

FIG. 2 is a view illustrating a system including an electronic device, an external device, a server, and a router according to an embodiment of the disclosure.

Referring to FIG. 2, in a system 2000, an operation of the electronic device 100, the external device 200, the server 300, or the like corresponds to that of FIG. 1. Therefore, the overlapped description is omitted.

The router 400 may be a router connecting the server 300 and devices included in the IoT network (the electronic device 100 and the external device 200). The router 400 may be disposed together in a space where the electronic device 100 and the external device 200 are disposed. The router 400 may be connected to the server 300 through an Internet network.

According to various embodiments, the electronic device 100 or the external device 200 may use the router 400 to communicate with the server 300.

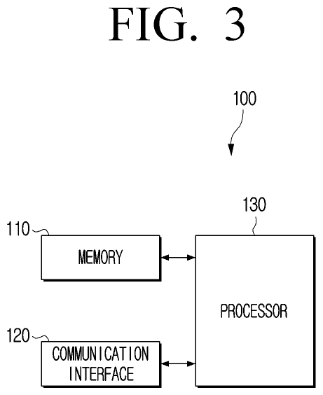

FIG. 3 is a block diagram illustrating a configuration of an electronic device according to an embodiment of the disclosure.

Referring to FIG. 3, the electronic device 100 may include at least one of memory 110, a communication interface 120, or at least one processor 130.

The electronic device 100 may be a device including an output part which may provide various information to a user. For example, the electronic device 100 may be a mobile device or a TV including a display and a speaker. Also, the electronic device 100 may be an AI speaker including a speaker. Also, the electronic device 100 may be referred to as an on-boarding helper.

The external device 200 may be a device included in the IoT network connected to the server 300. The external device 200 may be a device which does not include a display or a speaker and thus, may not output entire response information. Even if the external device 200 includes a display, the display may not be suitable for outputting the response information. For example, the number of emitting elements of a LED may be insufficient to output all the response information. For example, a size of the display may be too small to output all the response information.

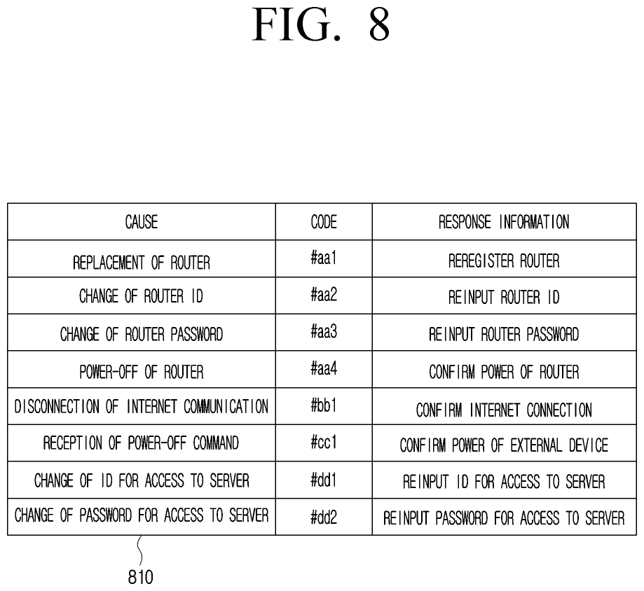

The memory 110 may store a plurality of response information for resolving a reason for event occurrence. To resolve one reason for event occurrence, one response information may be mapped and stored. The detailed description related to a reason for event occurrence and response information is described in FIG. 8.

The communication interface 120 may communicate with the external device 200 connected to the server 300. The external device 200 may mean a IoT device connected to the server 300.

According to various embodiments, the external device 200 may directly perform communication with the server 300. An example related to the above is described in FIG. 1.

According to various embodiments, the external device 200 may perform communication with the server 300 through the router 400. An example related to the above is described in FIG. 2.

The at least one processor 130, if the external device 200 and the server 300 are in a connection state, may receive a first packet including first connection state information from the external device 200 through the communication interface 120, and if there is an event that the external device 200 and the server 300 are not connected, receive a second packet including second connection state information and a reason for event occurrence from the external device 200 through the communication interface 120, and if it is identified that the external device 200 is disconnected from the server 300 based on the second connection state information included in the second packet, identify response information corresponding to the reason for the event occurrence included in the second packet among the plurality of response information stored in the memory 110, and may generate a UI guiding to connect the external device 200 to the server 300 based on the response information and provide the UI.

Through the communication interface 120, the at least one processor 130 may receive the first packet from the external device 200. The first packet may mean a communication packet transmitted from the external device 200.

The first packet may include connection state information (first connection state information). The connection state information may include information indicating whether the external device 200 is connected to the server 300. For example, connection state information may include 0 (a first value) or 1 (a second value). If connection state information is 0, the connection state information may represent a state that the external device 200 and the server 300 are not connected. If connection state information is 1, the connection state information may represent a state that the external device 200 and the server 300 are connected.

The at least one processor 130 may obtain (or extract) connection state information from the received first packet. Further, the at least one processor 130 may identify a connection state between the external device 200 and the server 300 based on the obtained connection state information.

If the connection state information includes ‘1’, the at least one processor 130 may identify that the external device 200 is connected to the server 300. Further, the at least one processor 130 may not perform a separate operation. This is because there is no need to provide a separate notification to the user in the state that the external device 200 is connected to the server 300.

If the connection state information includes ‘0’, the at least one processor 130 may identify that the external device 200 is not connected to the server 300. Further, the at least one processor 130 may provide a UI including response information to the user to connect the external device 200 to the server 300.

The second packet may include connection state information (second connection state information) and a reason for event occurrence.

First connection state information included in the first packet and second connection state information included in the second packet may have different values.

The second packet may include connection state information and a reason for event occurrence. The reason for the event occurrence may be referred to as event information or information on a cause of an event.

If second connection state information included in the second packet includes ‘0’, the at least one processor 130 may obtain a reason for event occurrence included in the second packet.

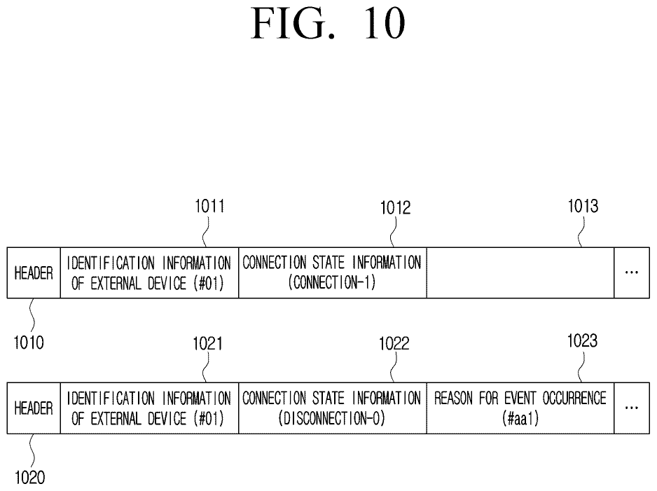

A structure related to the first packet and the second packet is described in FIG. 10.

The reason for the event occurrence may include information indicating the reason why a preset event occurs. The preset event may include an event that communication between the external device 200 and the server 300 is disconnected (or terminated). There may be various reasons why the communication between the external device 200 and the server 300 is disconnected. The reason for event occurrence may include at least one of replacement of a router, a change of a router identifier (ID), a change of a router password, power-off of a router, disconnection of the Internet communication, reception of a power-off command (reception of a power-off command with respect to the external device 200), a change of an ID for access to a server, or a change of a password for access to a server.

If second connection state information included in the second packet includes ‘0’, the at least one processor 130 may provide specific information to the user in order that the external device 200 is reconnected to the server 300. The specific information may be information for resolving a reason for event occurrence.

The at least one processor 130 may identify specific response information corresponding to a reason of event occurrence among a plurality of response information stored in the memory 110. The response information may be referred to as event resolution information.

If the response information is identified, the at least one processor 130 may generate a UI including the response information. The UI may include response information for guiding the user to connect the external device 200 to the server 300.

Meanwhile, the communication interface 120 may include at least one module among a Wi-Fi module and a Bluetooth module, wherein the at least one processor 130 may receive at least one among the first packet and the second packet in a broadcasting method through the at least one module.

According to various embodiments, the at least one processor 130 may receive a packet from the external device 200 through a Wi-Fi module. The at least one processor 130 may receive beacon information of a Software enabled Access Point (SoftAP) from the external device 200.

According to various embodiments, the at least one processor 130 may receive a packet from the external device 200 through a Bluetooth module. The at least one processor 130 may receive Bluetooth advertising information from the external device 200. The Bluetooth advertising information may be a Bluetooth advertising packet or a Bluetooth Low Energy (BLE) advertising packet.

If the communication interface 120 includes a Wi-Fi module and a Bluetooth module, the Wi-Fi module and the Bluetooth module may be disposed in one hardware (a communication interface). According to an embodiment, the Wi-Fi module and the Bluetooth module may be disposed in separate hardware (a communication interface), respectively.

According to various embodiments, the first packet transmitted in a state that the external device 200 is connected to the server 300 may be received through the Wi-Fi module. Also, the second packet transmitted in a state that the external device 200 is not connected to the server 300 may be received through the Bluetooth module.

According to various embodiments, the first packet transmitted in a state that the external device 200 is connected to the server 300 may be received through the Bluetooth module. Also, the second packet transmitted in a state that the external device 200 is not connected to the server 300 may be received through the Wi-Fi module.

Meanwhile, a reason for the event occurrence may include at least one of a reason related to a router, a reason related to Internet connection, a reason related to power, or a reason related to the server 300. The detailed description related to the reason for the event occurrence is described in FIG. 8.

Meanwhile, the at least one processor 130 may generate a UI including at least one of identification information of the external device 200, information indicating the event, the reason for the event occurrence, or response information.

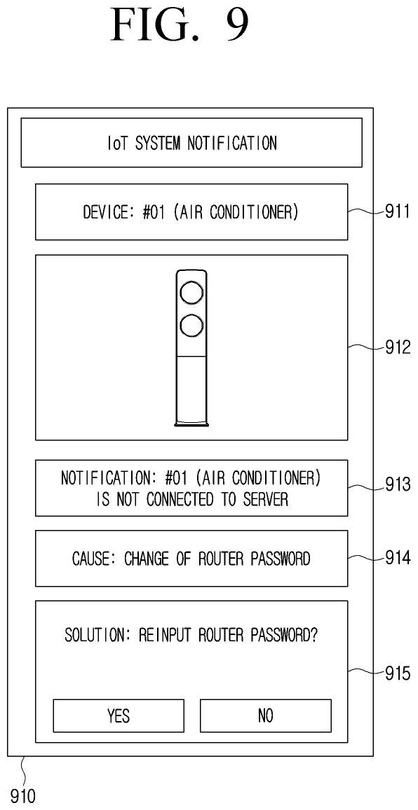

The identification information of the external device 200 may include model information of the external device 200. Information indicating the event may include at least one of text information indicating a type of event or image information indicating a type of event. The detailed description related to the UI is described in FIGS. 9, 15, 16, and 17.

Meanwhile, the electronic device 100 may further include memory 110 storing a response table mapping a plurality of reasons for event occurrence and response information for resolving each of the plurality of reasons for the event occurrence, wherein the at least one processor 130 may identify the response information corresponding the reasons for the event occurrence based the response table.

The electronic device 100 may store a response table including first response information for resolving a reason for first event occurrence and second response information for resolving a reason for second event occurrence in the memory 110. The at least one processor 130 may obtain (or extract) the reason for the first event occurrence included in the second packet. The at least one processor 130 may identify (or obtain) first response information corresponding to the reason for the first event occurrence included in the second packet among the plurality of response information based on the response table. An example related to the response table is described in FIG. 8.

Meanwhile, the electronic device 100 may further include memory 110 storing a registration device table including identification information of at least one pre-registered external device 200, may receive the second packet including the second connection state information, the reason for the event occurrence, and the identification information of the external device 200 through the communication interface 120, and if the identification information of the external device 200 included in the second packet is included in the registration device table, may identify the response information.

The registration device table may include identification information of the device pre-registered at the IoT network. The electronic device 100 may pre-store a registration device table in the memory 110. The at least one processor 130 may receive the registration device table from the server 300.

Through the communication interface 120, the at least one processor 130 may receive the second packet additionally including identification information of the external device 200 from the external device 200. The at least one processor 130 may obtain (or identify) identification information of the external device 200 included in the received second packet. Further, the at least one processor 130 may determine whether identification information of the identified external device 200 is included in the registration device table stored in the memory 110.

If the identification information of the identified external device 200 is included in the registration device table stored in the memory 110, the at least one processor 130 may determine that there is a need for providing a UI related to event occurrence to the user.

If the identification information of the identified external device 200 is not included in the registration device table stored in the memory 110, the at least one processor 130 may determine that there is no need for providing a UI related to event occurrence to the user.

According to various embodiments, user account information may be used instead of the identification information of the aforementioned external device 200. The second packet may additionally include the user account information. The at least one processor 130 may compare user account information received from the external device 200 and pre-registered user account information. If the user account information received from the external device 200 corresponds to the pre-registered user account, the at least one processor 130 may determine that there is a need for providing a UI related to event occurrence to the user.

Meanwhile, the electronic device 100 may further include memory 110 storing a response table mapping a plurality of reasons for event occurrence and response information for resolving each of the plurality of reasons for the event occurrence, wherein the at least one processor 130, if the identification information of the external device 200 is included in the registration device table, and the response information corresponding to the reason for the event occurrence is included in the response table, may generate a first UI guiding to reconnect the external device 200 to the server 300 and provide the first UI, and if the identification information of the external device 200 is included in the registration device table, and the response information corresponding to the reason for the event occurrence is not included in the response table, may generate a second UI guiding to reregister the external device 200 at the server 300 and provide the second UI.

Meanwhile, the at least one processor 130, if the identification information in the second packet is not included in the registration device table, may generate a third UI guiding to newly register the external device 200 at the server 300.

The reason for distinguishing the first UI to the third UI from one another is that an action to be taken by the user is different according to the reason for communication disconnection from the server 300. Therefore, the electronic device 100 may provide a different UI to a user based on whether the external device 200 is pre-registered or whether response information is found (identified).

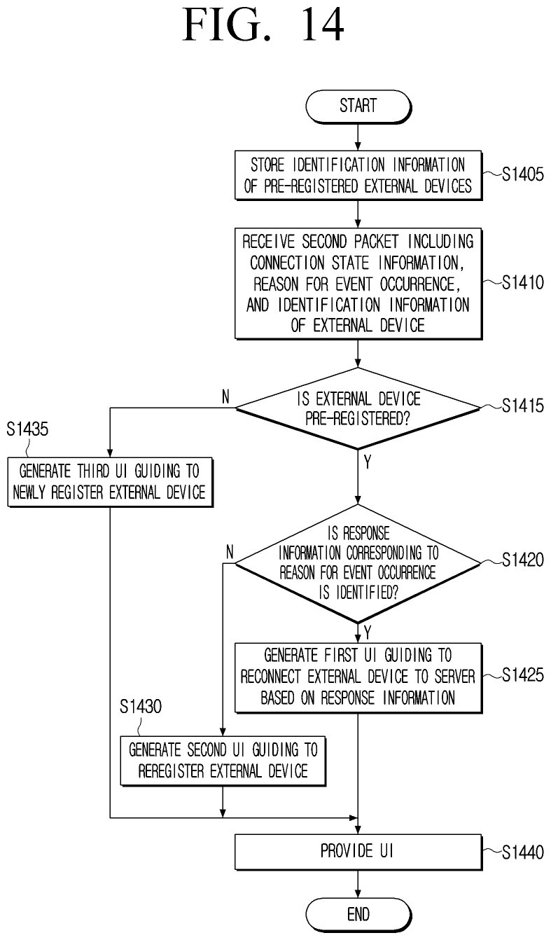

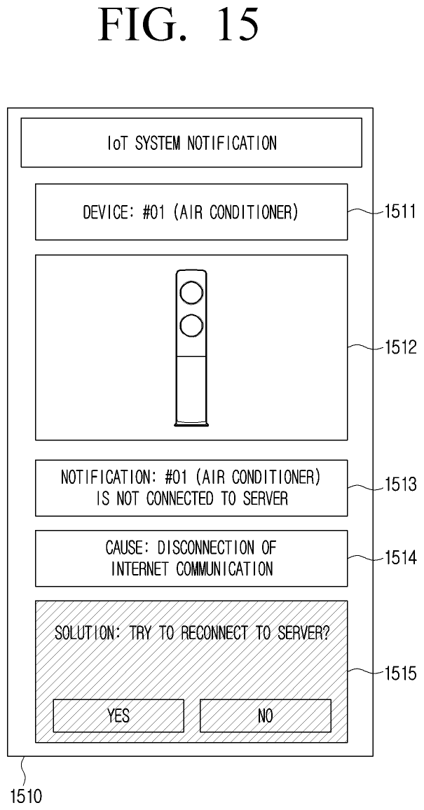

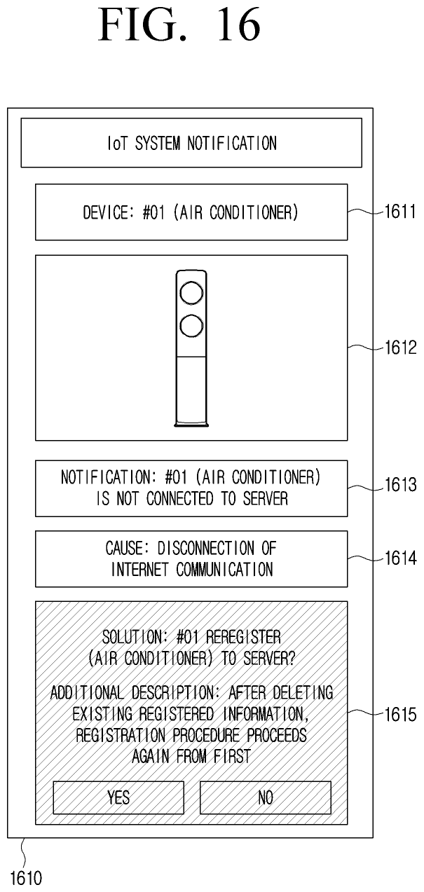

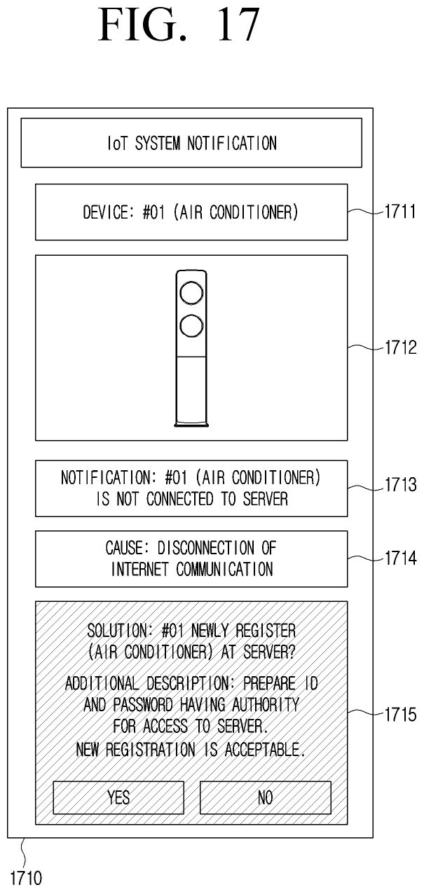

An entire operation providing the first UI to the third UI is described in FIG. 14. An example of the first UI is described in FIG. 15. An example of the second UI is described in FIG. 16. An example of the third UI is described in FIG. 17.

Meanwhile, the at least one processor 130, after a preset threshold time is elapsed from a time point when the first UI is provided, may receive a third packet including third connection state information from the external device 200 through the communication interface 120, and based on identifying that the external device 200 is disconnected from the server 300 according to the third connection state information included in the third packet, may generate the second UI guiding to reconnect the external device 200 to the server 300 and provide the second UI.

If the preset threshold time is elapsed from the time point when the first UI is provided to the user, the at least one processor 130 may determine whether the external device 200 is connected to the server 300. If the user takes a proper action through the first UI, the external device 200 is to be connected to the server 300. In spite of providing the first UI, if the user does not take any action or wrongly takes an action, it is required that the at least one processor 130 should provide a new second UI rather than the first UI to the user. The second UI may include simpler response information than that of the first UI. Time for processing the second UI may be longer than time for processing the first UI. However, response information included in the second UI may be simper that response information included in the first UI. The fact that response information is simple may mean that there are fewer operations to be taken by the user.

For example, the number of guide operations included in the first response information of the first UI may be more than the number of guide operations included in the second response information of the second UI. The guide operation may be behavior to be performed by the user to connect (including all of ‘reconnect’, ‘reregister’, and ‘newly register’) the external device 200 to the server 300.

Even though the first UI is provided, and the threshold time is elapsed, if the external device 200 is not connected to the server 300, it may be determined that the user does not properly take an action through the first UI.

Meanwhile, the electronic device 100 may further include the display 140, and the at least one processor 130 may control the display 140 to display a UI.

Meanwhile, the electronic device 100 may further include a speaker 170. Further, the at least one processor 130 may output response information through the speaker 170.

According to various embodiments, the at least one processor 130 may output an event occurrence notification (e.g. event information or preset beep sound) through the speaker 170 and may output a reason for event occurrence through the display 140.

Meanwhile, the provided UI is displayed through the display, the at least one processor 130 may display the UI in a pop-up form. The at least one processor 130 may display the UI as pop-up while the existing screen is displayed as it is.

According to various embodiments, the at least one processor 130 may obtain a size of the generated UI. Also, the at least one processor 130 may receive information about a size of the display of the external device 200 from the external device 200. If the information about the size of the display of the external device 200 is received, the at least one processor 130 may store information about the size of the display of the external device 200 in the memory 110. The at least one processor 130 may compare the size of the display of the external device 200 and a size of the UI. If the size of the UI is equal to or greater than the size of the display of the external device 200, the at least one processor 130 may output the generated UI onto the display 140 of the electronic device 100. If the size of the UI is smaller than the size of the display of the external device 200, the at least one processor 130 may transmit a control command and the UI to the external device 200 in order that the UI may be outputted on the display of the external device 200. The external device 200 may output the UI received from the electronic device 100 onto the display of the external device 200.

Specifically, if a horizontal size of the UI is greater than a horizontal size of the display of the external device 200 or a vertical size of the UI is greater than a vertical size of the display of the external device 200, the at least one processor 130 may output the generated UI onto the display 140 of the electronic device 100.

According to various embodiments, the external device 200 may determine whether it may provide response information about the event occurring in the external device 200. The external device 200 may store a response table mapping a plurality of reasons for event occurrence and response information for resolving each of the plurality of reasons for the event occurrence. The external device 200 may obtain response information corresponding to the identified reasons for the event occurrence. Further, the external device 200 may generate the UI including response information. Further, the external device 200 may obtain a size of the UI. Still further, the external device 200 may compare the size (area) of the UI and the size (or area) of the display of the external device 200. If the size of the UI is greater than the size of the display of the external device 200, the external device 200 may determine that it is not proper that the external device 200 directly provides the UI. Therefore, the external device 200 may transmit a packet including at least one of a reason for event occurrence, response information, or the generated UI to the electronic device 100. The electronic device 100 may provide the UI to the user based on the packet received from the external device 200.

Meanwhile, the electronic device 100 may receive the reason for the event occurrence from the external device 200 and thus, may provide an exact solution (response information) corresponding to the reason for the event occurrence to the user. If there is no proper output part in the external device 200 and it is not possible to provide sufficient information to the user, the electronic device 100 may provide sufficient information to the user.

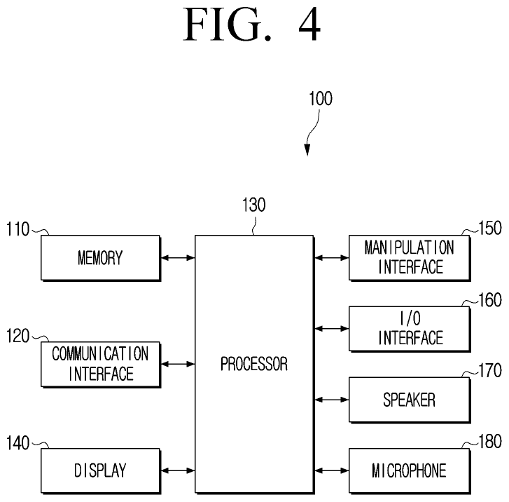

Meanwhile, only simple configuration constituting the electronic device 100 is shown and explained as above, but various configurations may be additionally included upon implementing. With respect to the above, the description is made with reference to FIG. 4 hereinafter.

FIG. 4 is a block diagram illustrating a detailed configuration of the electronic device of FIG. 3 according to an embodiment of the disclosure.

Referring to FIG. 4, the electronic device 100 may include at least one of memory 110, a communication interface 120, at least one processor 130, a display 140, a manipulation interface 150, an input/output (I/O) interface 160, a speaker 170, or a microphone 180. Meanwhile, the overlapped description of the same operation as the previously described operation is omitted.

According to various embodiments of the specification, the electronic device 100 may include, for example, at least one of a smart phone, a tablet personal computer (PC), a mobile phone, a desktop PC, a laptop PC, a personal digital assistant (PDA), or a portable multimedia player (PMP). In some examples, the electronic device 100 may include, for example, at least one of a television, a digital versatile disc (DVD) player, a media box (e.g. Samsung HomeSync™, Apple TV™, or Google TV™).

The memory 110 may be implemented as internal memory such as read-only memory (ROM) (e.g. electrically erasable programmable read-only memory (EEPROM)) or random-access memory (RAM) included in the at least one processor 130 or may be implemented as memory separate from the at least one processor 130. In this case, the memory 110 may be implemented as memory embedded in an electronic device 100 according to a use for data storage or may be implemented as memory detachable from the electronic device 100. For example, data for driving the electronic device 100 is stored in memory embedded in the electronic device 100 and data for an extension function of the electronic device 100 may be stored in memory detachable from the electronic device 100.

Meanwhile, memory embedded in the electronic device 100 may be implemented as at least one of volatile memory (e.g. dynamic RAM (DRAM), static RAM (SRAM), or synchronous dynamic RAM (SDRAM), etc.) or non-volatile memory (e.g. one time programmable ROM (OTPROM), programmable ROM (PROM), erasable and programmable ROM (EPROM), electrically erasable and programmable ROM (EEPROM), mask ROM, flash ROM, flash memory (e.g. NAND flash, NOR flash, etc.), a hard drive, or a solid state drive (SSD), and memory detachable from the electronic device 100 may be implemented as a memory card (e.g. a compact flash (CF) card, a secure digital (SD) card, a micro secure digital (Micro-SD) card, a mini secure digital (Mini-SD) card, an extreme digital (xD) card, a multi-media card (MMC), etc.), external memory connectible to a USB port (e.g. USB memory), or the like.

The communication interface 120 is a configuration performing communication with various types of external devices according to various types of communication methods. The communication interface 120 may include a wireless communication module or a wired communication module. Each communication module may be implemented in a form of at least one hardware chip.

The wireless communication module may be a module which communicates with an external device wirelessly. For example, the wireless communication module may include at least one module of a Wi-Fi module, a Bluetooth module, an infrared communication module, or other communication modules.

The Wi-Fi module and the Bluetooth module may perform communication in a Wi-Fi method and a Bluetooth method, respectively. In case of using the Wi-Fi module or the Bluetooth module, the module may receive and transmit various connection information such as a service set identifier (SSID) and a session key in advance, connect communication by using the connection information, and then receive and transmit various information.

The infrared communication module may perform communication based on an infrared data association (IrDA) technology which transmits data wirelessly in a short distance by using infrared light between visible light and a millimeter wave.

The other communication modules may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G) besides the aforementioned communication methods.

The wired communication module may be a module which communicates with an external device wiredly. For example, the wired communication module may include at least one of a Local Area Network (LAN) module, an Ethernet module, a pair cable, a coaxial cable, a fiber optic cable, or a Ultra Wide-Band (UWB) module.

The processor 130 may perform overall control operations of the electronic device 100. Specifically, the processor 130 performs a function of controlling operations of the electronic device 100 overall.

The processor 130 may be implemented as a digital signal processor (DSP) processing a digital signal, a microprocessor, or a time controller (TCON). Meanwhile, the processor is not limited thereto and may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machine (ARM) processor or may be defined based on the relevant terms. Also, the processor 130 may be implemented as a system on chip (SoC) in which processing algorithm is embedded or a large scale integration (LSI) and may be implemented in a form of a field programmable gate array (FPGA). Also, the processor 130 may perform various functions by executing computer executable instructions stored in the memory 110.

The display 140 may be implemented as a display having various forms such as a liquid crystal display (LCD), an organic light emitting diode (OLED) display, and a plasma display panel (PDP). The display 140 may include a driving circuit which may be implemented in a form such as an amorphous silicon thin film transistor (a-si TFT), a low temperature poly silicon (LTPS) TFT, or an organic TFT (OTFT), a backlight unit, or the like together therein. Meanwhile, the display 140 may be implemented as a touch screen coupled to a touch sensor, a flexible display, a three-dimensional display (a three dimensional (3D) display), or the like. Also, according to an embodiment of the disclosure, the display 140 may include not only a display panel outputting an image but also a bezel housing the display panel. In particular, according to an embodiment of the disclosure, the bezel may include a touch sensor (not shown) for sensing a user interaction.

The manipulation interface 150 may be implemented as a device such as a button, a touch pad, a mouse, and a keyboard or may be also implemented as a touch screen capable of performing the display function together with a manipulation input function. The button may be various types of buttons such as a mechanical button, a touch pad, or a wheel formed at any area such as a front part, a side part, a rear part, or the like of an appearance of a body of the electronic device 100.

The I/O interface 160 may be any one interface of a High Definition Multimedia Interface (HDMI), a Mobile High-Definition Link (MHL), a Universal Serial Bus (USB), a Display Port (DP), a Thunderbolt, a Video Graphics Array (VGA) port, a red green blue (RGB) port, a D-subminiature (D-SUB) connector, or a Digital Visual Interface (DVI). The I/O interface 160 may input and output at least one of an audio signal or a video signal. According to an embodiment, the I/O interface 160 may include a port which inputs and outputs only the audio signal and a port which inputs and outputs only the video signal as separate ports or may be implemented as one port which inputs and outputs all of the audio signal and the video signal. Meanwhile, the electronic device 100 may transmit at least one of the audio signal or the video signal to the external device (e.g. an external display device or an external speaker) through the I/O interface 160. Specifically, the output port included in the I/O interface 160 may be connected to the external device, and the electronic device 100 may transmit at least one of the audio signal or the video signal to the external device through an output port.

The I/O interface 160 may be connected to a communication interface. The I/O interface 160 may transmit information received from the external device to the communication interface or may transmit information received the communication interface to the external device.

The speaker 170 is a component outputting not only various audio data but also various alarm sound, voice messages, or the like.

The microphone 180 is a component for receiving and converting a user voice or other sound to audio data. The microphone 180 may receive the user voice in an active state. For example, the microphone 180 may be formed as an integral type as being integrated into an upper side of the electronic device 100 or in a front direction, a side direction thereof, or the like. The microphone 180 may include various components such as a microphone collecting a user voice in an analog form, an amplifier circuit amplifying the collected user voice, an A/D conversion circuit sampling and converting the amplified user voice to a digital signal, and a filter circuit removing a noise component from the converted digital signal.

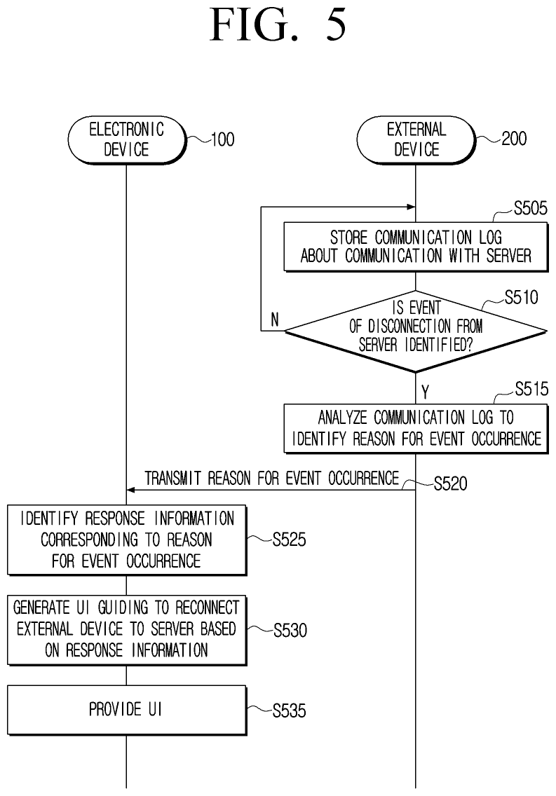

FIG. 5 is a flow chart illustrating an operation of identifying response information corresponding to a reason for event occurrence according to an embodiment of the disclosure.

Referring to FIG. 5, an external device 200 may store a communication log about communication with a server 300 at operation S505. The communication log may be information in which various communication records used for connecting the external device 200 to the server 300 are stored. The communication log may include at least one of a time point connected to the server 300, an ID, a password, a connection attempt event, a connection success event, or a connection failure event. The ID and the password may be included in the communication log in an encrypted state.

The external device 200 may determine whether an event of disconnection from the server 300 (or a preset event) is identified at operation S510. If the event of the disconnection from the server 300 is not identified operation S510, the external device 200 may repeat the operations S505 and S510.

If the event of the disconnection from the server 300 is identified at operation S510-Y, the external device 200 may analyze the communication log and identify a reason for event occurrence operation S515. Further, the external device 200 may transmit the reason for the event occurrence to the electronic device 100 operation S520. The reason for the event occurrence may be referred to as information on a cause of event occurrence.

The electronic device 100 may receive the reason for the event occurrence from the external device 200. The electronic device 100 may identify response information corresponding to the reason for the event occurrence operation S525. The response information may include a solution to the event (the event of disconnection between the external device 200 and the server 300).

The electronic device 100 may generate a UI guiding to reconnect the external device 200 to the server 300 based on the response information operation S530. Further, the electronic device 100 may provide the generated UI at operation S535. The operation of providing the UI may mean that the UI is outputted in an image form through a display or is outputted in an audio form through a speaker.

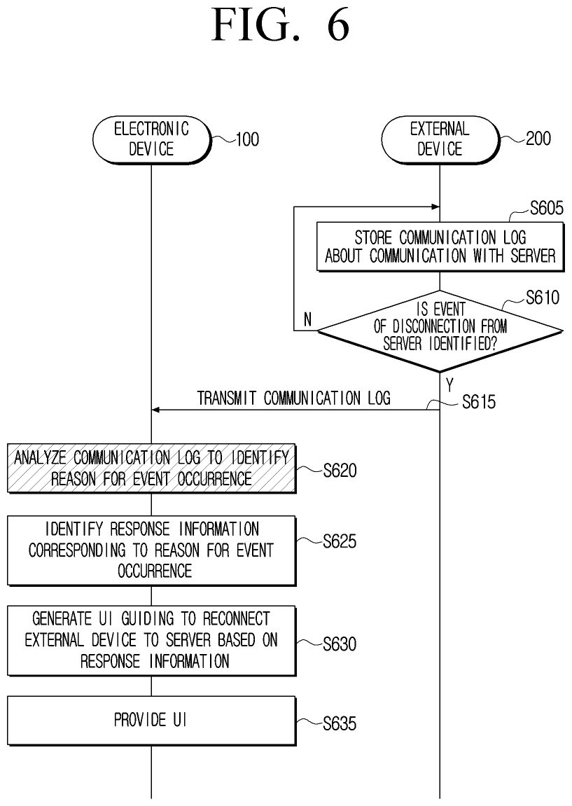

FIG. 6 is a flow chart illustrating an operation of identifying response information corresponding to a reason for event occurrence according to an embodiment of the disclosure.

Referring to FIG. 6, operations S605, S610, S625, S630, and S635 may correspond to the operations of S505, S510, S525, S530, and S535 of FIG. 5. Therefore, the overlapped description is omitted.

If the event of disconnection from a server 300 is identified at operation S610-Y, an external device 200 may transmit a communication log to an electronic device 100 at operation S615.

The electronic device 100 may receive the communication log from the external device 200. Then, the electronic device 100 may analyze the communication log and identify a reason for event occurrence at operation S620.

Thereafter, the electronic device 100 may perform the operations S625 to S635.

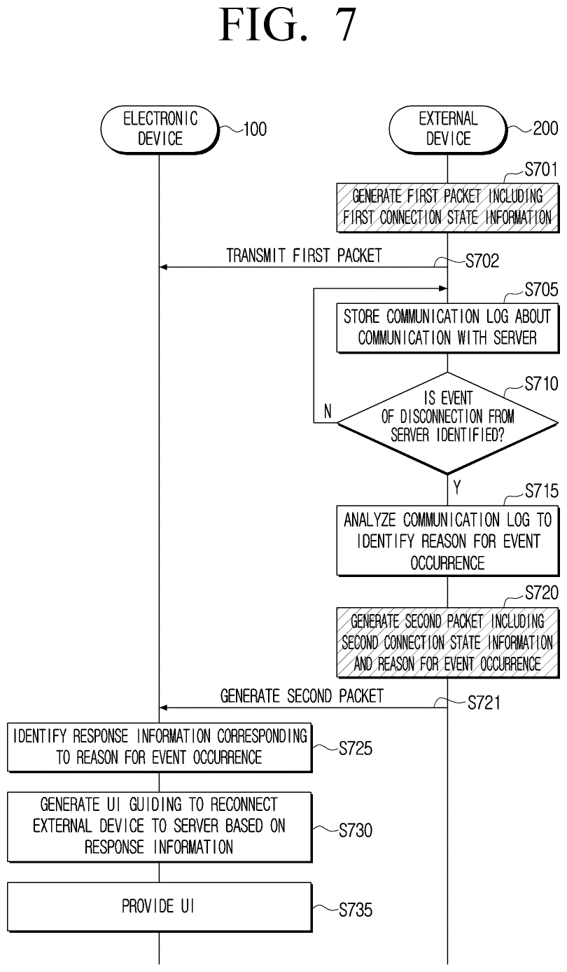

FIG. 7 is a flow chart illustrating an operation of identifying response information based on a packet transmitted from an external device 200 according to an embodiment of the disclosure.

Referring to FIG. 7, operations S705, S710, S715, S725, S730, and S735 may correspond to the operations S505, S510, S515, S525, S530, and S535 of FIG. 5. Therefore, the overlapped description is omitted.

An external device 200 may generate a first packet including first connection state information at operation S701. The first packet may include information indicating a connection state between the external device 200 and the server 300 (connection state information). The external device 200 may transmit the first packet to the electronic device 100 at operation S702.

Thereafter, the external device 200 may perform the operations S705, S710, and S715. Further, the external device 200 may generate a second packet including the second connection state information and the reason for the event occurrence at operation S720. The external device 200 may store the connection state information and the reason for the event occurrence in one communication packet. The external device 200 may transmit the second packet to the electronic device 100 at operation S721.

The electronic device 100 may receive the second packet from the external device 200. The electronic device 100 may determine whether to identify (or obtain) response information based on the second packet.

According to various embodiments, if the connection state information included in the second packet includes information indicating disconnection of the external device 200 from the server 300, the electronic device 100 may identify response information corresponding to the reason for the event occurrence at operation S725. Then, the electronic device 100 may perform the operations S730 and S735.

According to various embodiments, if the second packet includes a reason for event occurrence, the electronic device 100 may identify response information corresponding to the reason for the event occurrence at operation S725. Further, the electronic device 100 may perform the operations S730 and S735.

According to various embodiments, a method of transmitting the first packet and the second packet may be a broadcasting method.

FIG. 8 is a table representing response information corresponding to a reason of event occurrence according to an embodiment of the disclosure.

Referring to FIG. 8, the table 810 may represent response information which may be identified (or obtained) by an electronic device 100 according to a reason for event occurrence.

The table 810 may be a response table storing response information corresponding to the reason for the event occurrence. The response table may include information mapping a plurality of reasons for event occurrence and response information for resolving each of the plurality of reasons for the event occurrence.

If the reason for the event occurrence is replacement of a router (#aa1), the electronic device 100 may include content information ‘reregister the router’.

If the reason for the event occurrence is a change of a router ID (#aa2), the electronic device 100 may include content information ‘reinput the router ID’.

If the reason for the event occurrence is a change of a router password (#aa3), the electronic device 100 may include content information ‘reinput the router password’.

If the reason for the event occurrence is power-off of a router (#aa4), the electronic device 100 may include content information ‘confirm power of the router’.

If the reason for the event occurrence is disconnection of the Internet communication (#bb1), the electronic device 100 may include content information ‘confirm the Internet connection’.

If the reason for the event occurrence is reception of a power-off command (#cc1), the electronic device 100 may include content information ‘confirm power of the external device’.

If the reason for the event occurrence is a change of an ID for access to the server (#dd1), the electronic device 100 may include content information ‘reinput an ID for access to the server’.

If the reason for the event occurrence is a change of a password for access to a server (#dd2), the electronic device 100 may include content information ‘reinput a password for access to a server’.

The content information may include at least one of text information, image information, or audio information. The electronic device 100 may provide response information corresponding to the reason for the event occurrence in a form of image data or audio data. Specifically, the electronic device 100 may generate a UI including response information. Further, the electronic device 100 may display the UI including the response information on a display or may output the UI through a speaker.

FIG. 9 is a view illustrating a UI including response information according to an embodiment of the disclosure.

Referring to FIG. 9, an electronic device 100 may provide a UI 910. The UI 910 may include at least one of identification information 911 of the external device 200, image information 912 corresponding to the external device 200, event information 913, a reason for event occurrence 914, or response information 915.

The identification information 911 of the external device 200 may include information related to a device in which the event occurs.

The image information 912 corresponding to the external device 200 may include a thumbnail image (or a representative image) representing an event occurrence device.

The event information 913 may include a content of the event.

The reason for the event occurrence 914 may include information indicating why the event occurs.

The response information 915 may include information for resolving the event. The response information 915 may include user behavior information for resolving the event.

FIG. 10 is a view illustrating a packet including a reason for event occurrence according to an embodiment of the disclosure.

Referring to FIG. 10, packet 1010 may designate a communication packet transmitted in a connection state of the external device 200 and the server 300. The packet 1010 may correspond to the first packet of FIG. 7. The packet 1010 may include a first area 1011, a second area 1012, and a third area 1013. The first area 1011 may store identification information of the external device (#01). The second area 1012 may store connection state information (connection-1). If the state is in a connection state, 1 may be stored, and if the state is in a disconnection state, 0 may be stored. The third area 1013 may be an empty space.

The packet 1020 of FIG. 10 may designate a communication packet transmitted in a disconnection state of the external device 200 and the server 300. The packet 1020 may correspond to the second packet of FIG. 7. The packet 1020 may include a first area 1021, a second area 1022, and a third area 1023. The first area 1021 may store identification information of the external device (#01). The second area 1022 may store connection state information (disconnection-1). If the state is in a connection state, 1 may be stored, and if the state is in a disconnection state, 0 may be stored. The first area 1023 may store a reason for event occurrence (#aa1).

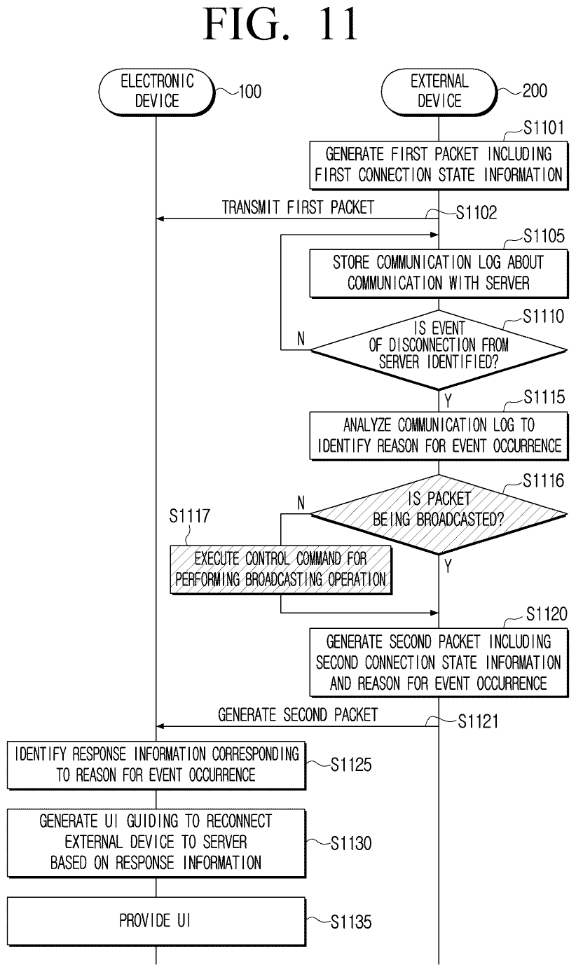

FIG. 11 is a flow chart illustrating an operation of determining broadcasting of a packet according to an embodiment of the disclosure.

Referring to FIG. 11, operations S1101, S1102, S1105, S1110, S1115, S1120, S1121, S1125, S1130, and S1135 may correspond to the operations S701, S702, S705, S710, S715, S720, S721, S725, S730, and S735 of FIG. 7. Therefore, the overlapped description is omitted.

After the reason for event occurrence is identified, the external device 200 may determine whether the packet is being broadcasted at operation S1116. The external device 200 may broadcast the packet according to a preset method. The external device 200 may determine whether the packet is being broadcasted through a communication interface included in the external device 200. If the packet is being broadcasted at operation S1116-Y, the external device 200 may directly generate a second packet including the second connection state information and the reason for the event occurrence at operation S1120. Further, the external device 200 may transmit the generated second packet to the electronic device 100 at operation S1121.

If the packet is not being broadcasted at operation S1116-N, the external device 200 may execute a control command for performing a broadcasting operation at operation S1117. The external device 200 may generate a control command for performing the broadcasting operation and execute the generated control command. The external device 200 may determine a packet used for performing the broadcasting operation as the second packet. The external device 200 may generate a second packet including the second connection state information and the reason for the event occurrence at operation S1120. Further, the external device 200 may transmit the generated second packet to the electronic device 100 at operation S1121.

Thereafter, the operations S1125 to S1135 may be performed.

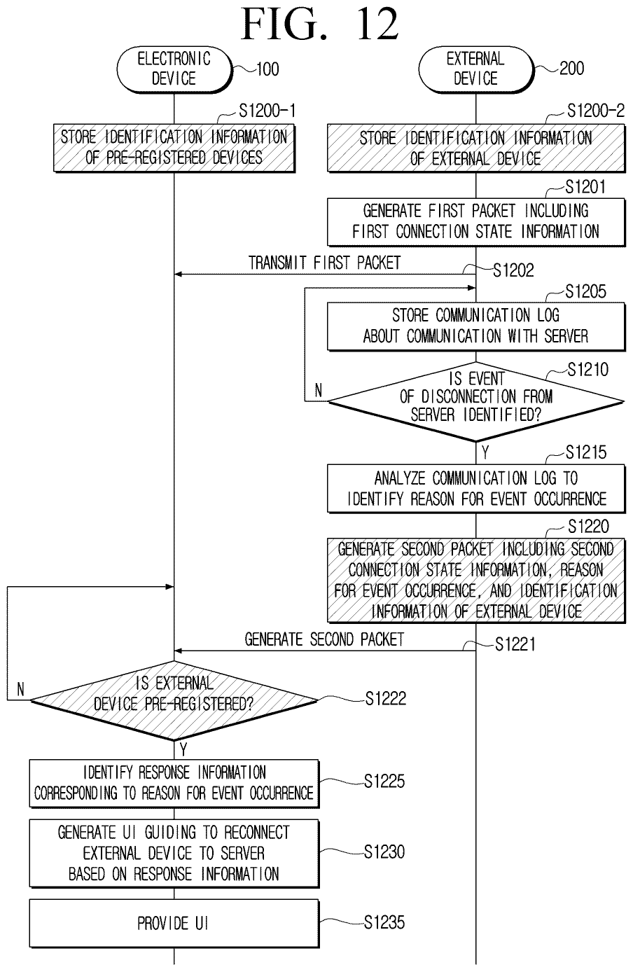

FIG. 12 is a flow chart illustrating an operation of determining whether an external device is pre-registered according to an embodiment of the disclosure.

Referring to FIG. 12, operations S1201, S1202, S1205, S1210, S1215, S1221, S1225, S1230, and S1235 may correspond to the operations S701, S702, S705, S710, S715, S721, S725, S730, and S735 of FIG. 7. Therefore, the overlapped description is omitted.

The electronic device 100 may store identification information of a plurality of pre-registered devices at operation S1200-1. The identification information of the plurality of pre-registered devices may be stored in a registration device table. The electronic device 100 may store the registration device table in the memory.

It is assumed that the IoT network includes a plurality of devices. The electronic device 100 may store identification information of a plurality of devices included (or registered) in the IoT network. The electronic device 100 may receive the identification information of the plurality of pre-registered devices through the server 300. The electronic device 100 may store the received identification information of the plurality of pre-registered devices (or identification information of the pre-registered external device) in memory of the electronic device 100.

The external device 200 may store identification information of the external device 200 itself in the memory of the external device 200 at operation S1200-2.

After the reason for the event occurrence is identified, the external device 200 may generate a second packet including second connection state information, a reason for event occurrence, and identification information of the external device 200 at operation S1220. Further, the external device 200 may transmit the second packet to the electronic device 100 at operation S1221.

The electronic device 100 may receive the second packet from the external device 200. Further, the electronic device 100 may determine whether the external device 200 is pre-registered based on information included in the second packet at operation S1222.

Specifically, the electronic device 100 may obtain identification information of the external device 200 included in the second packet. The electronic device 100 may determine whether the identification information of the external device 200 is included in the identification information of the plurality of pre-registered devices stored in the operation S1200-1. If the received identification information of the external device 200 is included in the identification information of the plurality of pre-registered devices, the electronic device 100 may determine that the external device 200 is a pre-registered device. If the received identification information of the external device 200 is not included in the identification information of the plurality of pre-registered devices, the electronic device 100 may determine that the external device 200 is not a pre-registered device.

If the external device 200 is not pre-registered at operation S1222-N, the electronic device 100 may repeat the operation S1222 repetitively.

If the external device 200 is pre-registered at operation S1222-Y, the electronic device 100 may perform the operations S1225 to S1235.

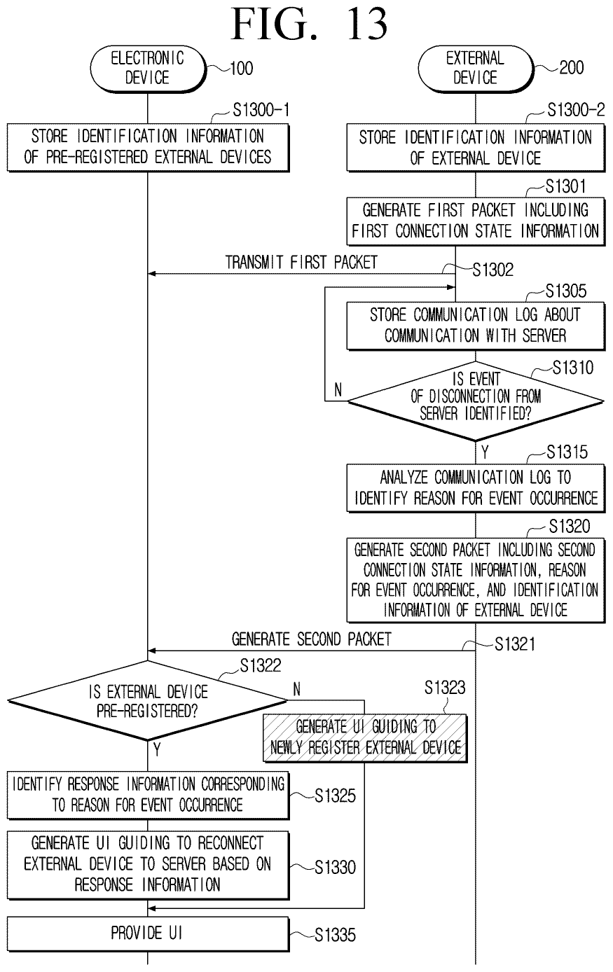

FIG. 13 is a flow chart illustrating an operation of guiding to newly register an external device according to an embodiment of the disclosure.

Referring to FIG. 13, operations S1300-1, S1300-2, S1301, S1302, S1305, S1310, S1315, S1320, S1321, S1322, S1325, S1330, and S1335 may correspond to the operations S1200-1, S1200-2, S1201, S1202, S1205, S1210, S1215, S1220, S1221, S1222, S1225, S1230, and S1235. Therefore, the overlapped description is omitted.

After receiving the second packet, an electronic device 100 may determine whether the external device is pre-registered at operation S1322. If the external device is not pre-registered at operation S1322-N, the electronic device 100 may generate a UI guiding to newly register an external device 200 at operation S1323. Further, the electronic device 100 may provide the generated UI at operation S1335.

Because the identification information of the external device 200 is not prestored (or pre-registered), the electronic device 100 may determine that the external device 200 is initially recognized by the IoT network. Therefore, the electronic device 100 may determine that it is required that the external device 200 should be newly registered. The electronic device 100 may provide response information (or guide information) related to new registration through the UI.

FIG. 14 is a flow chart illustrating an operation of generating various UIs according to an embodiment of the disclosure.

Referring to FIG. 14, an electronic device 100 may store identification information of the pre-registered external device at operation S1405. Further, the electronic device 100 may receive a second packet including connection state information, a reason for event occurrence, and identification information of the external device 200 at operation S1410.

The electronic device 100 may determine whether the external device 200 is pre-registered. The electronic device 100 may obtain identification information of the external device 200 included in the second packet. If the identification information of the external device 200 obtained from the second packet is included in the identification information of the pre-registered external device, the electronic device 100 may determine that the external device 200 is pre-registered.

If the external device 200 is pre-registered at operation S1415-Y, the electronic device 100 may determine whether response information corresponding to the reason for the event occurrence is identified at operation S1420.

If a solution corresponding to the reason for the event occurrence is identified, the electronic device 100 may identify response information including the solution. If a solution corresponding to the reason for the event occurrence is not identified, the electronic device 100 may determine that response information is not identified.

If response information corresponding to the reason for the event occurrence (first response information) is identified at operation S1420-Y, the electronic device 100 may generate a first UI guiding to reconnect the external device 200 to the server 300 based on the response information (first response information) at operation S1425. Because there is the response information for resolving the reason for the event occurrence, the electronic device 100 may provide the first UI guiding to try a reconnection operation to the user. The electronic device 100 may identify first response information corresponding to the reason for the event occurrence. The electronic device 100 may generate a first UI including the first response information. The description of the first UI is described in FIG. 15.

If the response information corresponding to reason for the event occurrence is not identified at operation S1420-N, the electronic device 100 may generate a second UI guiding to newly register the external device 200 at operation S1430. If the response information is not identified, it may be difficult to solve the problem with a general reconnection operation. Therefore, if the response information is not identified, the electronic device 100 may identify second response information to reregister the external device 200 at the server 300. Further, the electronic device 100 may generate a second UI including second response information. The description of the second UI is described in FIG. 16.

If the external device 200 is not pre-registered at operation S1415-N, the electronic device 100 may generate a third UI guiding to newly register the external device 200 at operation S1435. If the external device 200 is not pre-registered, the electronic device 100 may determine that the external device 200 is not included in the IoT network. Therefore, the electronic device 100 may identify third response information to newly register the external device 200. Specifically, the electronic device 100 may generate a third UI including third response information. The description of the third UI is described in FIG. 17.

The electronic device 100 may provide the generated UI (a first UI, a second UI, a third UI, etc.) at operation S1440.

FIG. 15 is a view illustrating a UI guiding to reconnect the external device 200 to the server 300 according to an embodiment of the disclosure.

Referring to FIG. 15, an electronic device 100 may provide a UI 1510. The UI 1510 may include at least one of identification information 1511 of the external device 200, image information 1512 corresponding to the external device 200, event information 1513, a reason for event occurrence 1514, or response information 1515.

The response information 1515 may include information for resolving the reason for event occurrence. The electronic device 100 may determine that it is required that the external device 200 should be reconnected to the server 300 in order to resolve the reason for event occurrence. The electronic device 100 may provide the UI 1510 including the response information 1515 to guide to a user input.

According to various embodiments, the response information 1515 may include behavior to be performed by the user in order to specifically perform an operation of reconnection. For example, the response information 1515 may include text information instructing to sequentially perform steps A, B, and C.

FIG. 16 is a view illustrating a UI guiding to reregister an external device 200 at a server 300 according to an embodiment of the disclosure.

Referring to FIG. 16, an electronic device 100 may provide a UI 1610. The UI 1610 may include at least one of identification information 1611 of the external device 200, image information 1612 corresponding to the external device 200, event information 1613, a reason for event occurrence 1614, or response information 1615.

The response information 1615 may include information for resolving the reason for event occurrence. The electronic device 100 may determine that it is required that the external device 200 should be reregistered at the server 300 in order to resolve the reason for event occurrence. The electronic device 100 may provide the UI 1610 including the response information 1615 to guide to a user input.

According to various embodiments, the response information 1615 may include description information about a reregistration process. For example, the response information 1615 may include text information describing the reregistration process ‘the existing registered information is deleted, and a registration procedure proceeds again from the first.’ According to various embodiments, the response information 1615 may include behavior to be performed by the user in order to specifically perform an operation of reregistration. For example, the response information 1615 may include text information instructing to sequentially perform steps D, E, and F.

FIG. 17 is a view illustrating a UI guiding to newly register an external device at a server according to an embodiment of the disclosure.

Referring to FIG. 17, an electronic device 100 may provide a UI 1710. The UI 1710 may include at least one of identification information 1711 of the external device 200, image information 1712 corresponding to the external device 200, event information 1713, a reason for event occurrence 1714, or response information 1715.

The response information 1715 may include information for resolving the reason for event occurrence. The electronic device 100 may determine that it is required that the external device 200 should be newly registered at the server 300 in order to resolve the reason for event occurrence. The electronic device 100 may provide the UI 1710 including the response information 1715 to guide to a user input.

According to various embodiments, the response information 1715 may include description information about a new registration process. For example, the response information 1715 may include text information describing a new registration process ‘Prepare an ID and a password having authority for access to the server. New registration is acceptable.’

According to various embodiments, the response information 1715 may include behavior to be performed by the user in order to specifically perform an operation of new registration. For example, the response information 1715 may include text information instructing to sequentially perform steps G, H, and I.

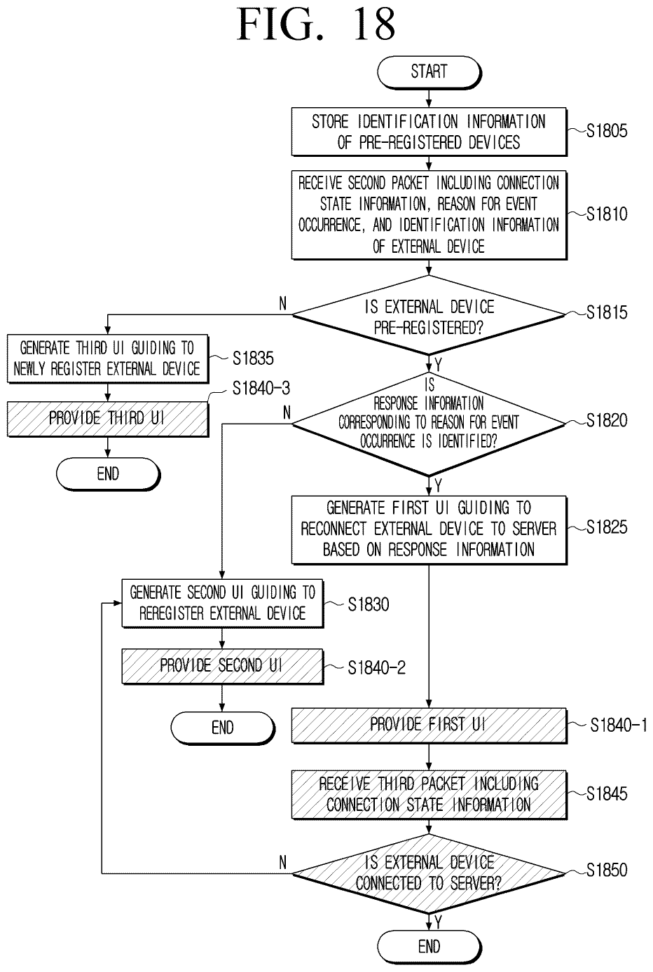

FIG. 18 is a flow chart illustrating an operation of determining whether an external device is connected to a server after an operation of providing the UI according to an embodiment of the disclosure.

Referring to FIG. 18, operations S1805, S1810, S1815, S1820, S1825, S1830, and S1835 may correspond to the operations S1405, S1410, S1415, S1420, S1425, S1430, and S1435 of FIG. 14. Therefore, the overlapped description is omitted.

After generating a first UI, the electronic device 100 may provide the first UI at operation S1840-1. After generating a second UI, the electronic device 100 may provide the second UI at operation S1840-2. After generating a third UI, the electronic device 100 may provide the third UI at operation S1840-3.

After providing the first UI, the electronic device 100 may receive a third packet including connection state information at operation S1845. The electronic device 100 may receive the third packet different from the second packet from the external device 200. The electronic device 100 may obtain connection state information included in the third packet.

The electronic device 100 may determine whether the external device 200 is connected to the server 300 based on the connection state information at operation S1850. The third packet received from the external device 200 may include information indicating whether the external device 200 is connected to the server 300 (connection state information). Therefore, the electronic device 100 may determine whether the external device 200 is connected to the server 300 based on the third packet.

If it is determined that the external device 200 is connected to the server 300 at operation S1850-Y, the electronic device 100 may not perform a separate operation.

If the external device 200 is not connected to the server 300 at operation S1850-N, the electronic device 100 may generate a second UI guiding to reregister the external device 200. Further, the electronic device 100 may provide the second UI at operation S1840-2.

To resolve the reason for the event occurrence, even though the first UI is provided, the attempt for reconnection may be failed due to various reasons. Therefore, it is required that the electronic device 100 should provide a preliminary solution to a preliminary user. Even after a preset time is elapsed from a time point when the first UI guiding to reconnection is provided, if the external device 200 is still not connected to the server 300, the electronic device 100 may provide the second UI guiding to a reregistration process of the external device 200 to the user.

Even if the attempt for connection is failed with the response information included in the first UI, the attempt for connection may succeed with the response information included in the second UI. Therefore, the user may be provided with new response information without a separate input.

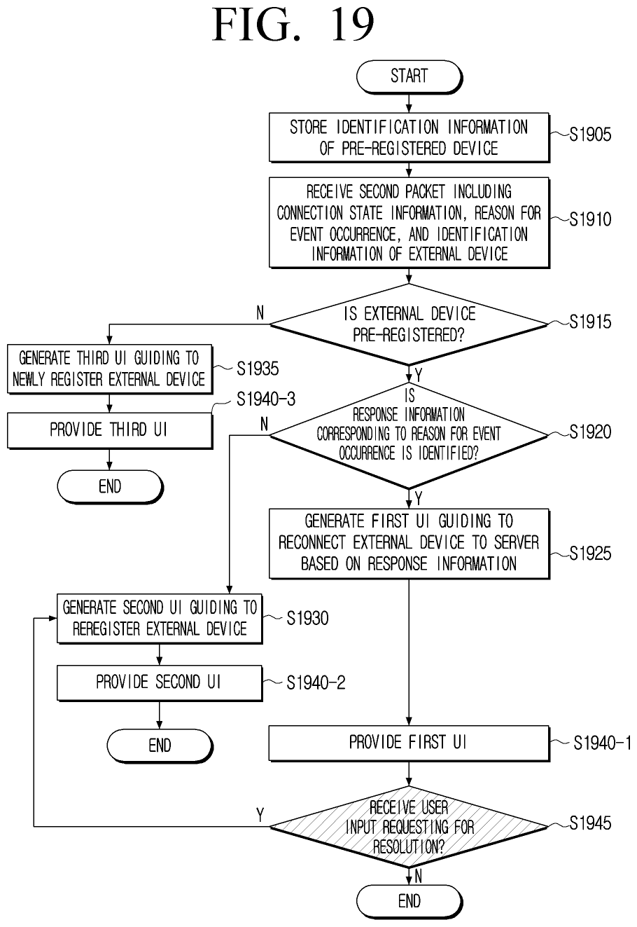

FIG. 19 is a flow chart illustrating an operation of generating a UI according to a user input requesting for resolution after providing the UI according to an embodiment of the disclosure.

Referring to FIG. 19, operations S1905, S1910, S1915, S1920, S1925, S1930, S1935, S1940-1, S1940-2, and S1940-3 may correspond to the operations S1805, S1810, S1815, S1820, S1825, S1830, S1835, S1840-1, S1840-2, and S1840-3 of FIG. 18. Therefore, the overlapped description is omitted.

After providing the first UI, the electronic device 100 may determine whether a user input requesting for resolution is received at operation S1945. Even though the user is provided with the first UI, the user still may not solve the reason for the event occurrence. In this case, the user may want to be provided with other solutions. The user input requesting for resolution may be a user input requesting other response information rather than the response information included in the first UI.

If the user input requesting for resolution is not received at operation S1945-N, the electronic device 100 may not perform a separate operation.

If the user input requesting for resolution is received at operation S1945-Y, the electronic device 100 may generate a second UI guiding to reregister the external device 200 at operation S1930. Further, the electronic device 100 may provide the second UI at operation S1940-2. The user may not resolve the reason for the event occurrence with the response information included in the first UI but may resolve the reason for the event occurrence with the response information included in the second UI.

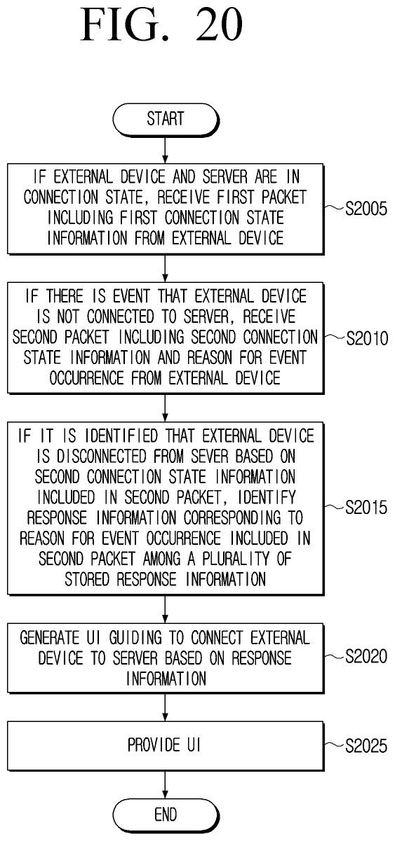

FIG. 20 is a flow chart illustrating a method of controlling an electronic device 100 according to an embodiment of the disclosure.

Referring to FIG. 20, a method of controlling the electronic device 100 communicating with an external device 200 which stores a plurality of response information and is connected to a server 300 includes, if the external device 200 and the server 300 are in a connection state, receiving a first packet including first connection state information from the external device 200 at operation S2005, if there is an event that the external device 200 is not connected to the server 300, receiving a second packet including second connection state information and a reason for event occurrence from the external device 200 at operation S2010, if it is identified that the external device 200 is disconnected from the server 300 based on the second connection state information included in the second packet, identifying response information corresponding to the reason for the event occurrence included in the second packet among the plurality of stored response information at operation S2015, generating a UI guiding to connect the external device 200 to the server 300 based on the response information at operation S2020, and providing the UI at operation S2025.

Meanwhile, a communication interface of the electronic device 100 may include at least one module among a Wi-Fi module and a Bluetooth module, wherein the receiving the first packet and the second packet at operations S2005, S2010) may include receiving the first packet and the second packet in a broadcasting method through the at least one module.

Meanwhile, a reason for the event occurrence may include at least one of a reason related to a router, a reason related to Internet connection, a reason related to power, or a reason related to the server 300.

Meanwhile, the generating UI at operation S2020 may include generating the UI including at least one of identification information of the external device 200, information indicating the event, the reason for the event occurrence, or response information.

Meanwhile, the electronic device 100 may store a response table mapping a plurality of reasons for event occurrence and response information for resolving each of the plurality of reasons for the event occurrence, wherein the identifying the response information at operation S2015 may include identifying the response information corresponding to the reasons for the event occurrence based on the response table.

Meanwhile, the electronic device 100 may store a registration device table including identification information of at least one pre-registered external device 200, wherein the receiving the second packet at operation S2010 may include receiving a second packet including the second connection state information, the reason for the event occurrence, and the identification information of the external device 200, and the identifying the response information at operation S2015 may include, if the identification information of the external device 200 included in the second packet is included in the registration device table, identifying the response information.

Meanwhile, the electronic device 100 may store a response table mapping a plurality of reasons for event occurrence and response information for resolving each of the plurality of reasons for the event occurrence, wherein the control method may further include, if the identification information of the external device 200 is included in the registration device table, and the response information corresponding to the reason for the event occurrence is included in the response table, generating a first UI guiding to reconnect the external device 200 to the server 300 and providing the first UI, and if the identification information of the external device 200 is included in the registration device table, and the response information corresponding to the reason for the event occurrence is not included in the response table, generating a second UI guiding to reconnect the external device 200 to the server 300 and providing the second UI.

Meanwhile, the control method may further include, after a preset threshold time is elapsed from a time point when the first UI is provided, receiving a third packet including third connection state information from the external device 200, and if it is identified that the external device 200 is disconnected from the server 300 according to the third connection state information included in the third packet, generating a second UI guiding to reregister the external device 200 at the server 300 and providing the second UI.

Meanwhile, the control method may further include, if the identification information included in the second packet is not included in the registration device table, generating a third UI guiding to newly register the external device 200 at the server 300.

Meanwhile, the control method may further include displaying the UI on the display of electronic device 100.

Meanwhile, the control method of the electronic device such as FIG. 2 may be implemented on the electronic device having configurations of FIGS. 3 and 4 and may be implemented on electronic devices having other configurations.

Meanwhile, the aforementioned methods according to various embodiments of the disclosure may be implemented in a form of an application installable in the existing electronic device.

Also, the aforementioned methods according to various examples of the disclosure may be implemented only with a software upgrade or a hardware upgrade with respect to the existing electronic device.

Also, it is possible to implement various examples of the disclosure as above through an embedded server included in the electronic device or an external server of at least one of the electronic device or the display device.

Meanwhile, according to an embodiment of the disclosure, various examples described above may be implemented as software including instructions stored in machine (e.g. a computer) readable storage media. The machine may refer to a device which calls instructions stored in the storage media and is operable according to the called instructions, wherein it may include an electronic device according to the disclosed embodiments. If the instructions are executed by a processor, the processor may perform a function corresponding to the instructions directly or by using other components under control of the processor. The instructions may include a code generated or executed by a compiler or an interpreter. The machine readable storage media may be provided in a form of a non-transitory storage medium. The term ‘non-transitory’ merely means that the storage media do not include a signal and are tangible, wherein the term does not distinguish a case that data is stored in the storage media semi-permanently from a case that data is stored in the storage media temporarily.

Also, according to an embodiment of the disclosure, the method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or on-line via an application store (e.g. play store™). In the case of on-line distribution, at least part of the computer program product may be stored at least temporarily or may be generated temporarily in a storage medium such as memory of a server of a manufacturer, a server of an application store, or a relay server.

Also, each of components (e.g. a module or a program) according to the various embodiments above may be configured as a single item or a plurality of items, wherein a partial subcomponent of the aforementioned relevant subcomponents may be omitted, or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, at least part of the operations may be executed in different orders or be omitted, or another operation may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory storing a plurality of response information and one or more computer programs;
communication circuitry communicating with an external device connected to a server; and
one or more processors communicatively coupled to the communication circuitry and the memory,
wherein the one or more computer programs include computer-executable instructions that, when executed by the one or more processors individually or collectively, cause the electronic device to:
based on the external device being connected to the server, receive a first packet including first connection state information from the external device through the communication circuitry,
based on there being an event that the external device is not connected to the server, receive a second packet including second connection state information and a reason for event occurrence from the external device through the communication circuitry,
based on identifying that the external device is disconnected from the server based on the second connection state information included in the second packet, identify response information corresponding to the reason for the event occurrence included in the second packet among the plurality of response information stored in the memory,
generate a user interface (UI) guiding to connect the external device to the server based on the response information, and
provide the UI.

2. The electronic device of claim 1,
wherein the communication circuitry:
includes at least one module among a Wireless Fidelity (Wi-Fi) module and a Bluetooth (BT) module, and
wherein the one or more computer programs further include computer-executable instructions that, when executed by the one or more processors individually or collectively, cause the electronic device to:
receive the first packet and the second packet in a broadcasting method through the at least one module.

3. The electronic device of claim 1, wherein the reason for the event occurrence:
includes at least one of a reason related to a router, a reason related to Internet connection, a reason related to power, or a reason related to the server.

4. The electronic device of claim 1, wherein the one or more computer programs further include computer-executable instructions that, when executed by the one or more processors individually or collectively, cause the electronic device to:
generate the UI including at least one of identification information of the external device, information indicating the event, the reason for the event occurrence, or the response information.

5. The electronic device of claim 1, further comprising:
memory storing a response table mapping a plurality of reasons for event occurrence and response information for resolving each of the plurality of reasons for the event occurrence,
wherein the one or more computer programs further include computer-executable instructions that, when executed by the one or more processors individually or collectively, cause the electronic device to:
identify the response information corresponding to the reasons for the event occurrence based on the response table.

6. The electronic device of claim 1, wherein the one or more computer programs further include computer-executable instructions that, when executed by the one or more processors individually or collectively, cause the electronic device to:
further include memory storing a registration device table including identification information of at least one pre-registered external device;
receive the second packet including the second connection state information, the reason for the event occurrence, and the identification information of the external device through the communication circuitry; and
based on the identification information of the external device included in the second packet being included in the registration device table, identify the response information.

7. The electronic device of claim 6, further comprising:
memory storing a response table mapping a plurality of reasons for event occurrence and response information for resolving each of the plurality of reasons for the event occurrence,
wherein the one or more computer programs further include computer-executable instructions that, when executed by the one or more processors individually or collectively, cause the electronic device to:
based on the identification information of the external device being included in the registration device table, and the response information corresponding to the reason for the event occurrence being included in the response table, generate a first UI guiding to reconnect the external device to the server and provide the first UI, and
based on the identification information of the external device being included in the registration device table, and the response information corresponding to the reason for the event occurrence being not included in the response table, generate a second UI guiding to reconnect the external device to the server and provide the second UI.

8. The electronic device of claim 7, wherein the one or more computer programs further include computer-executable instructions that, when executed by the one or more processors individually or collectively, cause the electronic device to:
after a preset threshold time is elapsed from a time point when the first UI is provided, receive a third packet including third connection state information from the external device through the communication circuitry; and
based on identifying that the external device is disconnected from the server according to the third connection state information included in the third packet, generate the second UI guiding to reconnect the external device to the server and provide the second UI.

9. The electronic device of claim 6, wherein the one or more computer programs further include computer-executable instructions that, when executed by the one or more processors individually or collectively, cause the electronic device to:
based on the identification information included in the second packet being not included in the registration device table, generate a third UI guiding to newly register the external device at the server.

10. The electronic device of claim 1, further comprising:
a display,
wherein the one or more computer programs further include computer-executable instructions that, when executed by the one or more processors individually or collectively, cause the electronic device to:
control the display to display the UI.

11. A method performed by an electronic device for communicating with an external device which stores a plurality of response information and is connected to a server, the method comprising:
based on the external device being connected to the server, receiving, electronic device, a first packet including first connection state information from the external device;
based on there being an event that the external device is not connected to the server, receiving, electronic device, a second packet including second connection state information and a reason for event occurrence from the external device;
based on it being identified that the external device is disconnected from the server based on the second connection state information included in the second packet, identifying, electronic device, response information corresponding to the reason for the event occurrence included in the second packet among the plurality of stored response information;
generating, electronic device, a user interface (UI) guiding to connect the external device to the server based on the response information; and
providing, electronic device, the UI.

12. The method of claim 11,
wherein communication circuitry of the electronic device:
includes at least one module among a Wireless Fidelity (Wi-Fi) module and a Bluetooth (BT) module, and
wherein the receiving the first packet and the second packet:
includes receiving the first packet and the second packet in a broadcasting method through the at least one module.

13. The method of claim 11, wherein the reason for event occurrence:
includes at least one of a reason related to a router, a reason related to Internet connection, a reason related to power, or a reason related to the server.

14. The method of claim 11, wherein the generating the UI includes:
generating the UI including at least one of identification information of the external device, information indicating the event, the reason for the event occurrence, or the response information.

15. The method of claim 11,
wherein the electronic device is configured to:
store a response table mapping a plurality of reasons for event occurrence and response information for resolving each of the plurality of reasons for the event occurrence, and
wherein the identifying the response information includes:
identifying the response information corresponding to the reasons for the event occurrence based on the response table.

16. The method of claim 12, further comprising:
storing, in a memory, a registration device table including identification information of at least one pre-registered external device;
receiving the second packet including the second connection state information, the reason for the event occurrence, and the identification information of the external device through the communication circuitry; and
based on the identification information of the external device included in the second packet being included in the registration device table, identifying the response information.

17. The method of claim 16, further comprising:
storing, in a memory, a response table mapping a plurality of reasons for event occurrence and response information for resolving each of the plurality of reasons for the event occurrence;
based on the identification information of the external device being included in the registration device table, and the response information corresponding to the reason for the event occurrence being included in the response table, generating a first UI guiding to reconnect the external device to the server and provide the first UI; and
based on the identification information of the external device being included in the registration device table, and the response information corresponding to the reason for the event occurrence being not included in the response table, generating a second UI guiding to reconnect the external device to the server and provide the second UI.

18. The method of claim 17, further comprising:
after a preset threshold time is elapsed from a time point when the first UI is provided, receiving a third packet including third connection state information from the external device through the communication circuitry; and
based on identifying that the external device is disconnected from the server according to the third connection state information included in the third packet, generating the second UI guiding to reconnect the external device to the server and provide the second UI.

19. One or more non-transitory computer-readable storage media storing one or more computer programs including computer-executable instructions that, when executed by one or more processors of an electronic device individually or collectively, cause the electronic device to perform operations, the operations comprising:
based on an external device being connected to a server, receiving, electronic device, a first packet including first connection state information from the external device;
based on there being an event that the external device is not connected to the server, receiving, electronic device, a second packet including second connection state information and a reason for event occurrence from the external device;
based on it being identified that the external device is disconnected from the server based on the second connection state information included in the second packet, identifying, electronic device, response information corresponding to the reason for the event occurrence included in the second packet among a plurality of stored response information;
generating, electronic device, a user interface (UI) guiding to connect the external device to the server based on the response information; and
providing, electronic device, the UI.

20. The one or more non-transitory computer-readable storage media of claim 19, the operations further comprising:
wherein communication circuitry of the electronic device:
includes at least one module among a Wireless Fidelity (Wi-Fi) module and a Bluetooth (BT) module, and
wherein the receiving the first packet and the second packet:
includes receiving the first packet and the second packet in a broadcasting method through the at least one module.
